(19) United States
(12) Patent Application Publication
(10) Pub. No.: US 2015/0336475 A1
(43) Pub. Date: Nov. 26, 2015

(54) SPINDLE GEAR UNIT FOR AN ADJUSTING MECHANISM IN A MOTOR VEHICLE AND VEHICLE SEAT

(71) Applicant: JOHNSON CONTROLS METALS AND MECHANISMS GMBH & CO. KG, Solingen (DE)

(72) Inventor: Andreas Hoffmann, Wuelfrath (DE)

(21) Appl. No.: 14/647,926

(22) PCT Filed: Jul. 8, 2013
(86) PCT No.: PCT/EP2013/064374

§ 371 Date: May 28, 2015

(30) Foreign Application Priority Data
Jan. 30, 2013 (DE) 10 2013 001 802.1

(51) Int. Cl. B60N 2/02; F16H 25/20; B60N 2/06; F16H 57/039

(52) U.S. Cl. CPC B60N 2/0232; F16H 57/039; F16H 25/20; B60N 2/06; F16H 2057/02082

(57) ABSTRACT

A spindle gear unit (10) for an adjusting mechanism in a motor vehicle, especially in a motor vehicle seat, includes a housing (15) which has a first housing part (20) and a second housing part (22) and accommodates gear unit elements (40, 50, 60, 70). The first housing part (20) includes a first flange segment (23a) and the second housing part (22) includes a second flange segment (23b). The first flange segment (23a) and the second flange segment (23b) complement each other to provide a part of a flange (23). The flange (23) is encompassed by a securing element (28) for a form-fit connection of the two housing parts (20, 22). A vehicle seat is also provided having the spindle gear unit.

### CROSS REFERENCE TO RELATED APPLICATIONS

This application is a United States National Phase Application of International Application PCT/EP2013/064374 filed Jul. 8, 2013 and claims the benefit of priority under 35 U.S.C. §119 of German Patent Application DE 10 2013 001 802.1 filed Jan. 30, 2013, the entire contents of which are incorporated herein by reference.

### FIELD OF THE INVENTION

The invention relates to a spindle gear unit for an adjusting mechanism in a motor vehicle with a housing which comprises a first housing part and a second housing part, for receiving gear unit elements and to a vehicle seat with such a spindle gear unit.

### BACKGROUND OF THE INVENTION

Spindle gear units of the type in question are used, in particular, in vehicle seat longitudinal adjusters driven by electric motor, or for electric window opening mechanisms of motor vehicles. As an alternative to the electric drive, the spindle gear units can also be driven manually, for example by means of “step by step gear units” connected upstream, or other manual drives.

DE 103 62 040 B4 discloses a spindle gear unit of the type in question. The spindle gear unit comprises a housing which consists of two housing parts which are connected to each other by riveting. The rivet bolts are integrated in one of the two housing parts. However, not every housing material is suitable as rivet material.

DE 103 58 586 A1 discloses a screw connection for connecting two housing parts of a gear unit housing. Due to the additional and small screws which have to be screwed into one of the two housing parts, this solution has disadvantages in terms of cost. The supply of the small screws in the assembly process is complicated and sensitive in respect of malfunctions of the process sequence. The screw connection constitutes the clocking process step in the series manufacturing process. In addition, in the case of small gear unit housings, the screws cannot be screwed in at the same time.

### SUMMARY OF THE INVENTION

The invention is based on the problem of improving a spindle gear unit for an adjusting mechanism of the type mentioned at the beginning, in particular by a simple and cost-effective connection of the housing parts, and of improving a vehicle seat by use of such a spindle gear unit.

According to the invention, a spindle gear unit for an adjusting mechanism in a motor vehicle, comprises a housing, which comprises a first housing part and a second housing part, for receiving gear unit elements. The first housing part comprises a first flange segment and the second housing part comprises a second flange segment. The first flange segment and the second flange segment complement each other to form a part of a flange. The flange is encompassed by a securing element for the form-fitting connection of the two housing parts

Owing to the fact that the first housing part comprises the first flange segment and the second housing part comprises the second flange segment, the first flange segment and the second flange segment complement each other to form the part of a flange, and the flange is encompassed by the securing element for the form-fitting connection of the two housing parts, a simple, cost-effective and fixed connection of the housing parts can be achieved.

During the assembly, in a first step, the housing parts are positioned with respect to each other, and are preferably inserted one inside the other in a form-fitting manner in at least one direction in space. The, in particular, two housing parts, which are designed as housing halves, are secured against opening by means of the securing element which is pushed, in particular pressed, onto the housing flanges on both sides.

The first flange segment and the second flange segment preferably completely form the flange. This is expedient in particular in the case of spindle gear units with a housing composed of precisely two housing parts. However, it is also possible for the housing to be composed of three or more housing parts. Each housing part here can comprise a flange segment, and all of the flange segments together form the flange. Alternatively, only two housing parts of the three or more housing parts have a flange segment and the remaining housing parts which do not have a flange segment are not involved in the formation of the flange.

The securing element is preferably a locking ring which encompasses the flange. A cylindrical basic geometry of the locking ring enables the latter to be of simple design and to be producible cost-effectively. The locking ring is in particular made of metal or plastic.

A particularly fixed connection between the flange and the locking ring is achieved in that the flange has an undercut in which a projection of the locking ring engages. Said undercut of the flange is advantageously an encircling groove, in particular in the outer cylindrical circumferential surface of the flange, and the projection of the locking ring comprises at least one radially inwardly pointing clip lug. A plurality of clip lugs or a completely encircling clip lug can also be provided on the locking ring.

Another securing means which is known per se, for example a screw connection, can also be provided between the flange and the locking ring.

If the locking ring and the flange each have a circular basic shape, the angular position of the locking ring about the longitudinal axis thereof does not have to be aligned in relation to the flange during the assembly.

The spindle gear unit customarily interacts with a spindle by an internal thread of a spindle nut of the spindle gear unit being in engagement with an external thread of the spindle such that a rotation of the spindle nut brings about a relative movement between the spindle gear unit and the spindle.

In a preferred embodiment of the spindle gear unit according to the invention, the flange and the securing element surround the spindle in sections, i.e. the spindle protrudes through the flange and the securing element, which is pushed onto the flange and is preferably a locking ring.

A spindle gear unit with precisely two flanges which are encompassed by one securing element in each case can be produced in a simple manner and can be combined with the spindle during the assembly process with little effort by the two flanges and the two securing elements being penetrated by the spindle.

The spindle gear unit is preferably fastened to a component of the adjusting mechanism. For this purpose, the housing of the spindle gear unit can be mounted in a bearing bracket. The spindle advantageously runs through two openings in the bearing bracket, and the bearing bracket encompasses the two flanges in such a manner that the securing elements are secured in a form-fitting manner in the axial direction on the flanges. The bearing bracket here is preferably a metal plate which is bent in a U-shaped manner, with two limbs which each have a hole for the passage of the spindle. Additional fastening sections for fastening the bearing bracket to the adjusting mechanism, in particular fastening sections offset at right angles, can be provided at the ends of the limbs.

The spindle gear unit according to the invention can be used in a motor vehicle for driving adjusting mechanisms, which are known per se, for example for window opening mechanisms of motor vehicles or for vehicle seats, in particular motor vehicle seats.

The spindle gear unit according to the invention is particularly suitable for use in vehicle seats with a backrest and a seat part, in particular if the vehicle seat comprises a seat longitudinal adjuster as the adjusting mechanism, and the spindle gear unit serves a drive of the seat longitudinal adjuster. For this purpose, the seat longitudinal adjuster has at least one first rail fixed to the vehicle and a second rail connected to the seat part, wherein the first rail and the second rail are mounted so as to be displaceable mutually and with respect to each other, the spindle gear unit is connected to the one of the two rails and the spindle is connected to the other of the two rails.

An electric motor driving the spindle gear unit can be moved together with the vehicle seat in the longitudinal direction when the spindle gear unit is connected to the second rail in a manner fixed to the seat part and the spindle is connected fixedly to the rail fixed to the vehicle. However, it is also conceivable for the spindle to be connected to the seat structure or to the second rail in a manner rotatable about the longitudinal axis of the spindle and to be driven, i.e. rotated, by the spindle gear unit. In the case of such a solution, the spindle interacts with a spindle nut which is connected non-rotatably to the vehicle structure or to the first rail. In this case, the spindle nut is not part of the spindle gear unit.

The spindle gear unit is preferably driven by an electric motor. However, other drives, for example step by step systems which are known per se, are also combinable with the spindle gear unit.

The invention is explained in more detail below with reference to an advantageous exemplary embodiment which is illustrated in the figures. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic illustration of a vehicle seat with a spindle gear unit for the longitudinal adjustment;

FIG. 2 is an exploded illustration of a spindle gear unit known from the prior art;

FIG. 3 is a perspective view of a spindle gear unit according to the invention before the installation of the locking rings; and

FIG. 4 is a view corresponding to FIG. 3, showing the spindle gear unit after the installation of the locking rings.

### DESCRIPTION OF THE PREFERRED EMBODIMENTS

A vehicle seat 1 for a motor vehicle has a seat part 3 and a backrest 2, the inclination of which is adjustable relative to the seat part 3. Two first rails 5 which run parallel to each other and are fixed to the vehicle and two second rails 7 which are fixed to the seat part and are in each case guided in a first rail 5 are provided for the longitudinally adjustable mounting of the vehicle seat 1 in the vehicle. In the vehicle, one pair of rails 5, 7 is arranged on the tunnel side and the other pair of rails 5, 7 is arranged on the sill side.

The vehicle seat 1 is longitudinally adjustable by electric motor in a manner known per se. For this purpose, an electric motor is positioned on a crossmember connected to the two second rails 7, which are mounted in a manner fixed to the seat part. On at least one seat side of the vehicle seat 1, an output shaft of the electric motor is connected, preferably by means of a further elastic shaft, to a spindle gear unit 10 which interacts with a spindle 30. A rotation of the output shaft of the electric motor leads to a rotation of the one spindle nut 40 of the spindle gear unit 10 and thereby to a relative movement between the spindle gear unit 10 and the spindle 30.

The spindle 30 is arranged in a stationary manner in a cavity, which is formed by the first rail 5 and the second rail 7, and is held at the two ends thereof by a respective spindle holder which is connected fixedly to the first rail 5 fixed to the vehicle structure. The spindle gear unit 10 is connected fixedly to the second rail 7 and, in the present case, is likewise arranged in the cavity formed by the first rail 5 and the second rail 7. Owing to the relative movement between the spindle gear unit 10 and the spindle 30, an energizing of the electric motor therefore results in a relative movement between first rail 5 and second rail 7 and, accordingly, in a longitudinal displacement of the vehicle seat 1.

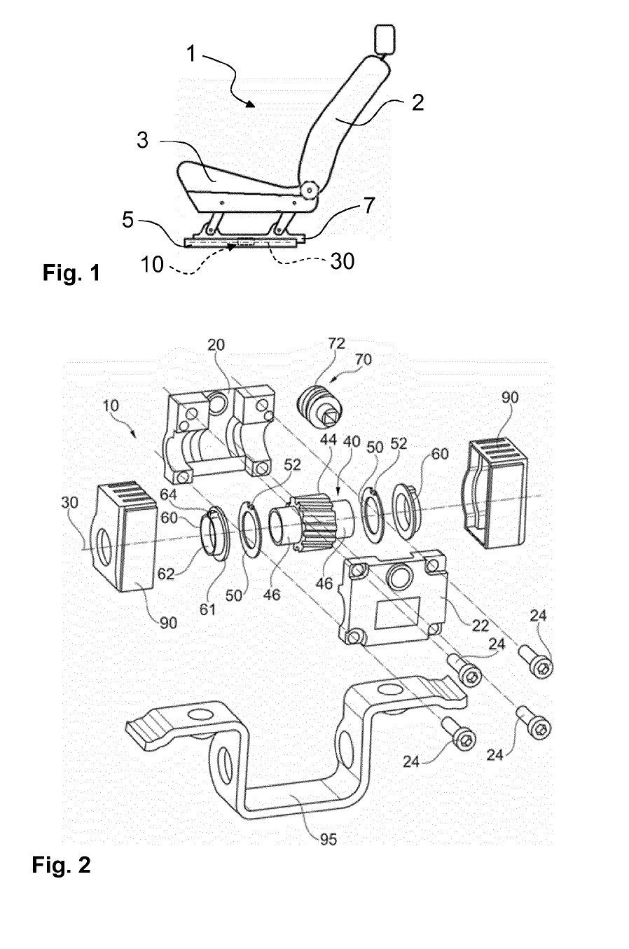

The spindle gear unit 10 is discussed in more detail below. FIG. 1 shows a spindle gear unit 10 known from the prior art.

The spindle gear unit 10 comprises a housing 15 which is composed of a first housing part 20 and a second housing part 22, and internally accommodates gear unit elements, which are also described in more detail below, for interaction with a spindle 30.

In the present case, the two housing parts 20, 22 are connected to each other by four screws 24. Each of the four screws 24 protrudes in each case through one passage hole in the second housing part 22 and is screwed by the external thread thereof into a respective internal thread of the first housing part 20.

The housing 15 forms an interior space and bearing regions for, firstly, the spindle nut 40 and, secondly, a worm 70, which together form a worm gear unit stage. The axis of rotation of the spindle nut 40 defines an axial direction which, in the case of spindle gear units for vehicle seat longitudinal adjusters, is frequently oriented approximately in the direction of travel. The axis of rotation of the spindle nut 40 is identical to the center axis of the spindle 30 and defines the directional details used below.

The housing 15 is open continuously in the axial direction for receiving the spindle 30, which is only illustrated in schematized form in FIGS. 1 and 2 by a dashed line. The spindle 30 has an external thread along the axial extent thereof for interaction with the spindle nut 40. For this purpose, the spindle nut 40 has an internal thread which is in engagement with the external thread of the spindle 30. An external toothing 44 of the spindle nut interacts with the worm 70.

The spindle nut 40 has a respective bearing surface 46 in the axial direction on both sides of the external toothing 44, said bearing surface being cylindrical and having an external diameter which is smaller than the external diameter of the external toothing 44 at the lowest points of the teeth, i.e. is smaller than the internal circle of said external toothing 44. A flat thrust washer 50 which comprises two main surfaces which are spaced apart from each other by the material thickness of the thrust washer, each point outward and are oriented perpendicular to the axial direction, is plugged onto each of the two outer bearing surfaces 46. The two main surfaces are preferably completely coated with a sliding lacquer.

The thrust washer 50 has a projection 52 which projects axially in the prior art embodiment shown, but can also be formed radially. In the mounted state, said axial projection 52 engages between two teeth of the external toothing 44, as a result of which a rotational securing of the thrust washer relative to the external toothing 44 is obtained. Said rotational securing can have a small amount of play which can be adjusted, for example, by adaptation of the dimensions of the projection 52. However, basically, the thrust washer 50 is coupled to the rotational movement of the spindle nut 40 because of the projection 52.

On the two outer bearing surfaces 46, a bearing bushing 60, which has a ring 61 which substantially corresponds in terms of the geometry thereof to the thrust washer 50, and a collar 62 which has a smaller external diameter and faces away from the external toothing 44, sits in each case next to that side of each thrust washer 50 which faces away from the external toothing 44. The internal diameter of the collar 62 approximately corresponds to the external diameter of the associated bearing surface 46. A lug 64 projects in the radial direction on the collar 62 of the bearing bushing 60. The bearing bushing 60 is preferably made of metal.

Bearing flutes for receiving the bearing bushings 60 are provided in the first housing part 20. The housing 15 also has a recess (not illustrated in FIG. 2) which receives the lug 64, and therefore the bearing bushing 60 cannot rotate in relation to the housing 15. In a modification of the exemplary embodiment, the lug 64 and the recess are omitted.

Furthermore, the worm 70 is mounted in the housing 15. The axis of said worm extends substantially at a right angle and is offset from the axis of the spindle nut 40 and the spindle 30. The worm 70 has a worm toothing 72 on the outer circumference thereof and, in the interior, a polygonal receptacle for receiving a driving, in particular elastic shaft. The worm 70 is preferably rotatably mounted in the housing 15 by a ball bearing at each axial end. In addition, bearing bushings (not illustrated in FIG. 1), similar to the bearing bushings 60, can be provided for the mounting of the worm gear in the housing 15.

The gear unit is encompassed in a manner known per se by two shells 90 made from rubber or a corresponding material suitable for noise reduction and is accommodated in a substantially U-shaped bearing bracket 95 which, in the present case, is fastened to the second rail 7 of the vehicle seat longitudinal adjuster.

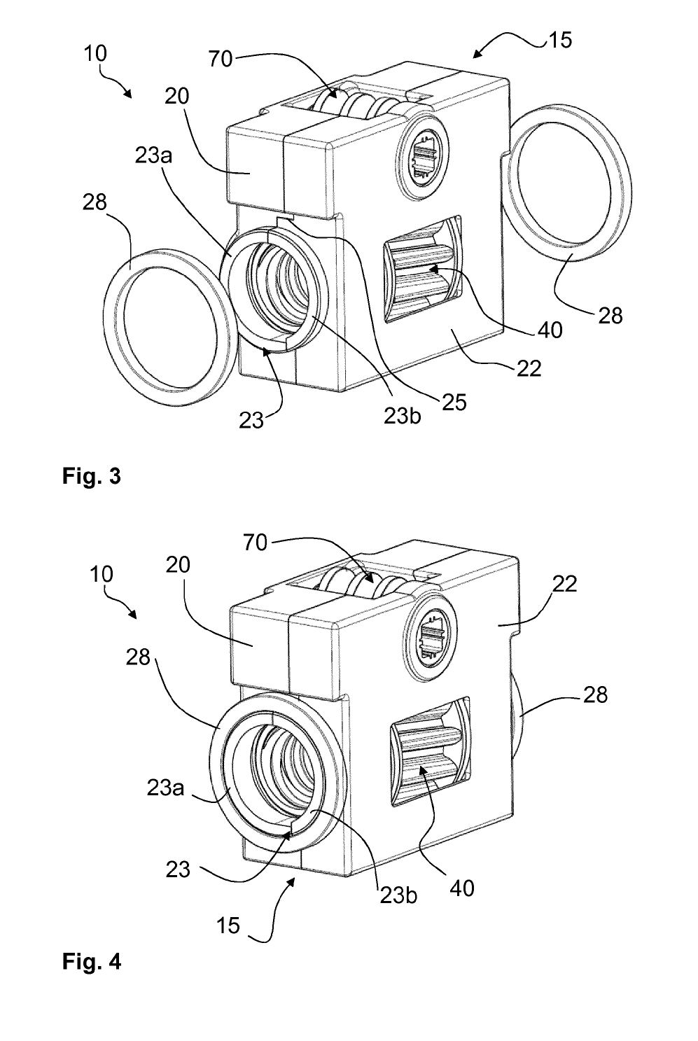

FIGS. 3 and 4 illustrate the spindle gear unit according to the invention, the interior construction of which, unless described differently below, corresponds to the previously described prior art.

The first housing part 20 and the second housing part 22 bear against each other in a form-fitting manner. For this purpose, the touching contact surfaces of the two housing parts 20, 22 have corresponding steps 25, and therefore the two housing parts 20, 22 can be positioned on each other in the manner of a plug-in connection in a joining direction and, in particular, are connected to each other in a form-fitting manner transversely with respect to said joining direction. The plug-in connection secures the housing parts 20, 22 in all directions in space, with the exception of a direction opposed to the joining direction.

In the region of the two receiving openings for the spindle 30, the first housing part 20 in each case has a first flange segment 23a. The first flange segment 23a is a shoulder which is in the shape of a segment of a circle and runs in the axial direction, i.e. in the direction of the spindle 30. A second flange segment 23b is provided in each case in a corresponding manner on the second housing part 22. When the housing parts 20, 22 bear against each other in a form-fitting manner, the first flange segment 23a and the second flange segment 23b mutually complement each other to form a circular flange 23 which surrounds the spindle 30 without touching the latter.

In order to secure the two housing parts 20, 22 against opening counter to the joining direction, at least one securing element is provided in the form of a locking ring 28 which encompasses the flange 23 in a form-fitting manner such that the two housing parts are also fixed with respect to each other counter to the joining direction.

The locking ring 28 is secured against release from the flange 23 in the axial direction by the installation of the housing 20, 22 into the bearing bracket 95. For this purpose, the flange 23 preferably has an undercut in which the locking ring engages in a form-fitting manner, for example by means of a clip connection. As a result, the strength of the connection between the flange 23 and the locking ring 28 is increased. The undercut of the flange 23 and the clip geometry of the locking ring 28 are preferably provided in an encircling manner, but can also be formed only in sections.

In the direction of the spindle 30 on both sides of the housing 20, 22, preferably precisely one flange 23 and precisely one locking ring 25 are provided, which, in the ready assembled state of the spindle gear unit 10, encompass the spindle 30.

During the assembly of the spindle gear unit, the two locking rings 28 are supplied and are pressed onto the two flanges 23 at the same time from both sides. This assembly process can be monitored by means of a simple force-displacement scan.

The features disclosed in the above description, the claims and the drawings may be of importance both individually and in combination for realizing the invention in the various refinements thereof.

While specific embodiments of the invention have been shown and described in detail to illustrate the application of the principles of the invention, it will be understood that the invention may be embodied otherwise without departing from such principles.

1. A spindle gear unit for an adjusting mechanism in a motor vehicle, the spindle gear unit comprising:
a housing comprising a first housing part and a second housing part, for receiving gear unit elements, wherein the first housing part comprises a first flange segment and the second housing part comprises a second flange segment, the first flange segment and the second flange segment complement each other to form a part of a flange, and
a securing element, wherein the flange is encompassed by the securing element for the a form-fitting connection of the two housing parts.

2. The spindle gear unit as claimed in claim 1, wherein the first flange segment and the second flange segment completely form the flange.

3. The spindle gear unit as claimed in claim 1, wherein the securing element is a locking ring which encompasses the flange.

4. The spindle gear unit as claimed in claim 3, wherein the flange has an undercut in which a projection of the locking ring engages.

5. The spindle gear unit as claimed in claim 4, wherein the undercut of the flange is an encircling groove, and the projection of the locking ring comprises at least one clip lug.

6. The spindle gear unit as claimed in claim 3, wherein the locking ring and the flange each have a circular basic shape.

7. The spindle gear unit as claimed claim 1 in, further comprising
a spindle; and
a spindle nut with an internal thread in engagement with an external thread of the spindle such that a rotation of the spindle nut brings about a relative movement between the spindle gear unit and the spindle.

8. The spindle gear unit as claimed in claim 7, wherein the flange and the securing element surround the spindle in sections.

9. The spindle gear unit as claimed in claim 8, wherein the spindle gear unit has precisely two flanges which are encompassed by one securing element in each case, and the spindle penetrates the two flanges and the two securing elements.

10. The spindle gear unit as claimed in claim 9, further comprising a bearing bracket wherein the housing is mounted in the bearing bracket, the spindle runs through two openings in the bearing bracket and the bearing bracket encompasses the two flanges in such a manner that the securing elements are secured in a form-fitting manner in an axial direction on the flanges.

11. A vehicle seat comprising:
a backrest
a seat part; and
a spindle gear unit for a vehicle adjusting mechanism, the spindle gear unit comprising:
a housing comprising a first housing part and a second housing part, for receiving gear unit elements, wherein the first housing part comprises a first flange segment and the second housing part comprises a second flange segment and the first flange segment and the second flange segment complement each other to form a part of a flange; and
a securing element, wherein the flange is encompassed by the securing element for a form-fitting connection of the two housing parts.

12. The vehicle seat as claimed in claim 11, further comprising: a seat longitudinal adjuster as the adjusting mechanism and the spindle gear unit serves a drive of the seat longitudinal adjuster.

13. The vehicle seat as claimed in claim 12, further comprising a spindle, wherein the seat longitudinal adjuster has at least one first rail fixed to the vehicle and a second rail connected to the seat part, wherein the first rail and the second rail are mounted so as to be displaceable mutually and with respect to each other, and the spindle gear unit is connected to the one of the two rails and the spindle is connected to the other of the two rails.

14. The vehicle seat as claimed in claim 13, wherein the spindle gear unit is connected to the second rail and the spindle is connected fixedly to the first rail.

15. The vehicle seat as claimed in claim 11, further comprising an electric motor, wherein the spindle gear unit is driven by the electric motor.
